(19) United States
(12) Patent Application Publication
(10) Pub. No.: US 2019/0050118 A1
(43) Pub. Date: Feb. 14, 2019

(54) METHOD AND DEVICE ENABLING FUNCTION INTERFACES OF APPLICATION BY USE OF PRESSURE

(71) Applicant: ZTE CORPORATION, Shenzhen (CN)

(72) Inventor: Tao Zhang, Shenzhen (CN)

(73) Assignee: ZTE CORPORATION, Shenzhen (CN)

(21) Appl. No.: 16/078,931

(22) PCT Filed: Sep. 27, 2016
(86) PCT No.: PCT/CN2016/100393

§ 371 Date: Aug. 22, 2018

(30) Foreign Application Priority Data
Mar. 17, 2016 (CN) 201610159147.4

(51) Int. Cl. G06F 3/0482; G06F 3/0481; G06F 3/0484; G06F 8/61; G06F 8/65

(52) U.S. Cl. CPC G06F 3/0482; G06F 3/04817; G06F 8/65; G06F 8/61; G06F 3/0484

(57) ABSTRACT

Disclosed are a method, an apparatus and a terminal for implementing a function interface of an application by pressure. The method includes: extending an application component attribute according to a preset pressure information specification; extending a parsing mechanism and a packaging mechanism according to the extended application component attribute; acquiring data of a preset pressure operation function interface menu carried in an installation package of an application when the application is installed or updated by using the extended parsing mechanism and packaging mechanism, and storing the data of the preset pressure operation function interface menu of the application in a storage unit; when determining in a desktop application that a pressure operation is to select the function interface of the application, retrieving the data of the corresponding preset pressure operation function interface menu from the storage unit according to icon information of the application; and presenting the data.

### TECHNICAL FIELD

The present disclosure relates to a data processing technology of a smart terminal, and more particularly, to a method and apparatus for implementing a function interface of an application by pressure.

### BACKGROUND

At present, a solution for a user to realize functions of individual applications by pressure on a screen of a smart terminal under an Android operating system is as follows: in program of a desktop application, an Extensible Markup Language (XML) file or other file format is used to uniformly manage pressure operation interface information of other applications on the smart terminal, for example: an application interface class name, an application package name, startup pressure function information, a pressure function name, a type corresponding to the startup pressure function information, etc.; after the desktop application is started, data of pressure operation interface information of individual corresponding application which has been configured will be parsed; if pressure operation interface information of a certain application exists in the desktop, when the user presses this application on the screen heavily, a corresponding function menu of this application will pop up, and when the user clicks on a certain item in the function menu or moves to a certain item in the function menu and leave the screen, the screen will skip to the corresponding function interface of the application.

However, in the related art, the pressure operation of the application can only be implemented on the desktop application if the corresponding pressure operation interface (Activity, Service, Broadcast Receiver and Content Provider, etc.) information of the application is added to the desktop application in advance. If a third-party application is newly installed on the smart terminal, but pressure operation interface information of this application is not added and saved in the desktop application, then a pressure operation pop-up function menu of this application cannot be implemented on the desktop application, thereby reducing the user experience.

This section provides background information related to the present disclosure which is not necessarily prior art.

### SUMMARY

In view of this, the embodiments of the present disclosure are directed to providing a method and apparatus for implementing a function interface of an application by pressure, so as to solve the defects in the related art that the corresponding pressure operation interface information of the application has to be uniformly configured in the desktop in advance, which provides convenience for a third-party application to support pressure operation character, and improves the user experience.

To achieve the above objects, the technical solutions of the embodiments of the present disclosure are implemented as follows.

The embodiments of the present disclosure provide a method for implementing a function interface of an application by pressure, including:

extending an application component attribute according to a preset pressure information specification;

extending a parsing mechanism and a packaging mechanism according to the extended application component attribute;

acquiring data of a preset pressure operation function interface menu carried in an installation package of an application when the application is installed or updated by using the extended parsing mechanism and packaging mechanism, and storing the data of the preset pressure operation function interface menu of the application in a storage unit;

when determining in a desktop application that a pressure operation is to select the function interface of the application, retrieving the data of the corresponding preset pressure operation function interface menu from the storage unit according to icon information of the application; and

presenting the data of the corresponding preset pressure operation function interface menu.

In the foregoing solution, the determining in the desktop application that the pressure operation is to select the function interface of the application includes:

when a duration of the pressure operation on an icon of the application is greater than or equal to a preset duration, acquiring a pressure value of the pressure operation on the icon of the application; and

when the pressure value of the pressure operation is greater than or equal to a preset pressure threshold, determining that the pressure operation is to select the function interface of the application.

In the foregoing solution, the extending the application component attribute according to the preset pressure information specification includes:

extending the application component attribute according to a startup interface of the pressure operation, service information of the pressure operation, and a service parameter of the pressure operation of the application in the preset pressure information specification.

In the foregoing solution, the data of the preset pressure operation function interface menu is formulated by the preset pressure information specification.

In the foregoing solution, the presenting the data of the corresponding preset pressure operation function interface menu includes:

presenting the data of the corresponding preset pressure operation function interface menu on a desktop through an animation pop-up view.

In the foregoing solution, the application component attribute include an Activity component attribute, a Service component attribute, a Broadcast Receiver component attribute and a Content Provider component attribute.

The embodiments of the present disclosure further provide an apparatus for implementing a function interface of an application by pressure, including:

an extension module configured to extend an application component attribute according to a preset pressure information specification; and extend a parsing mechanism and a packaging mechanism according to the extended application component attribute;

a conversion module configured to acquire data of a preset pressure operation function interface menu carried in an installation package of an application when the application is installed or updated by using the extended parsing mechanism and packaging mechanism, and store the data of the preset pressure operation function interface menu of the application in a storage unit;

a processing module configured to, when determining in a desktop application that a pressure operation is to select the function interface of the application, retrieve the data of the corresponding preset pressure operation function interface menu from the storage unit according to icon information of the application; and

a presentation module configured to present the data of the corresponding preset pressure operation function interface menu.

In the foregoing solution, the processing module is specifically configured to, when a duration of the pressure operation on an icon of the application is greater than or equal to a preset duration, acquire a pressure value of the pressure operation on the icon of the application; and when the pressure value of the pressure operation is greater than or equal to a preset pressure threshold, determine that the pressure operation is to select the function interface of the application.

In the foregoing solution, the extension module is specifically configured to extend the application component attribute according to a startup interface of the pressure operation, service information of the pressure operation, and a service parameter of the pressure operation of the application in the preset pressure information specification.

In the foregoing solution, the presentation module is specifically configured to present the data of the corresponding preset pressure operation function interface menu on a desktop through an animation pop-up view.

In the foregoing solution, the data of the preset pressure operation function interface menu is formulated by the preset pressure information specification; and

the application component attribute includes an Activity component attribute, a Service component attribute, a Broadcast Receiver component attribute and a Content Provider component attribute.

The embodiments of the present disclosure further provide a computer storage medium which may store an execution instruction, wherein the execution instruction is configured to execute the method for implementing a function interface of an application by pressure in the foregoing embodiments.

According to the method and the apparatus for implementing a function interface of an application by pressure provided by the embodiments of the present disclosure, the application component attribute is extended according to the preset pressure information specification by an Android terminal; the parsing mechanism and the packaging mechanism are extended according to the extended application component attribute; the data of the preset pressure operating function interface menu carried in the installation package of the application when the application is installed or updated is acquired by using the extended parsing mechanism and the extended packaging mechanism, and the data of the preset pressure operating function interface menu of the application is stored in the storage unit; when determining in the desktop application that the pressure operation is to select the function interface of the application, the data of the corresponding preset pressure operation function interface menu is retrieved from the storage unit according to the icon information of the application; and the data of the corresponding preset pressure operation function interface menu is presented. The method extends a system framework of the Android terminal according to the preset pressure information specification, and supports the data of the preset pressure operation function interface menu for the application configured according to the preset pressure information specification, solves the defects in the related art that the corresponding pressure operation interface information of the application has to be uniformly configured in the desktop in advance, provides convenience for third-party applications to support the pressure operation characters and improves the user experience.

This section provides a summary of various implementations or examples of the technology described in the disclosure, and is not a comprehensive disclosure of the full scope or all features of the disclosed technology.

### BRIEF DESCRIPTION OF THE DRAWINGS

FIG. 1 is a flow chart of an embodiment of a method for implementing a function interface of an application by pressure according to the present disclosure;

FIG. 2 is a structural schematic diagram of an embodiment of an apparatus for implementing a function interface of an application by pressure according to the present disclosure; and

FIG. 3 is a structural schematic diagram of an embodiment of a terminal for implementing a function interface of an application by pressure according to the present disclosure.

### DETAILED DESCRIPTION

The technical solutions in the embodiments of the present disclosure will be clearly and completely described below with reference to the accompanying drawings in the embodiments of the present disclosure.

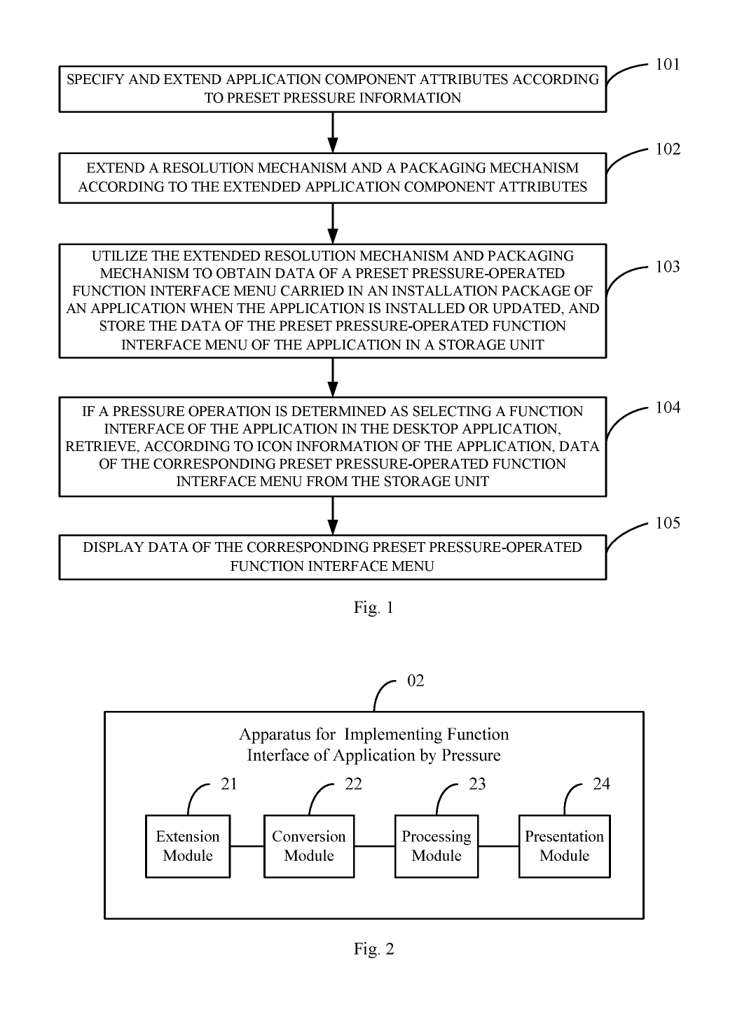

FIG. 1 is a flow chart of an embodiment of a method for implementing a function interface of an application by pressure according to the present disclosure. As shown in FIG. 1, the method for implementing a function interface of an application by pressure of the present disclosure is applied to a smart terminal having an Android operating system (hereinafter referred to as an Android terminal), and the specific method steps are as follows.

In step 101, an application component attribute is extended according to a preset pressure information specification.

The Android terminal expands the application component attribute in an Android system framework according to the preset pressure information specification. The preset pressure information specification is formulated and defined by a manufacturer of the Android terminal, and includes a standard specification for a startup interface of the pressure operation, service information of the pressure operation, and a service parameter of the pressure operation of most applications in the market. The application component attribute includes an Activity component attribute, a Service component attribute, a Broadcast Receiver component attribute and a Content Provider component attribute.

The Android terminal extends the startup interface of the pressure operation, the service information of the pressure operation, and the service parameter of the pressure operation of the application in the preset pressure information specification to the Active component attribute, the Service component attribute, the Broadcast Receiver component attribute, and the Content Provider component attribute, to form the extended application component attribute, so that the extended application component attribute carries the pressure operation interface information of the application.

In step 102, a parsing mechanism and a packaging mechanism are extended according to the extended application component attribute.

The Android terminal expands the parsing mechanism and the packaging mechanism according to the extended application component attribute. To be specific, a resource parsing process is perfected according to the extended application component attribute, so that parsing of the data of the preset pressure operation function interface menu carried in the newly installed or updated application can be supported, to obtain the extended parsing mechanism; and a packaging tool is modified and compiled according to the extended application component attribute, and a packaging process is perfected, so that packaging of the data of the preset pressure operation function interface menu carried in the newly installed or updated application can be supported, to obtain the extended packaging mechanism.

In step 103, data of a preset pressure operating function interface menu carried in an installation package of an application when the application is installed or updated is acquired by using the extended parsing mechanism and the extended packaging mechanism, and the data of the preset pressure operating function interface menu of the application is stored in a storage unit.

When the user installs or updates an application to the Android terminal, the Android terminal uses the extended parsing mechanism and the extended packaging mechanism to parse and package the installation package of the application, acquires the data of the preset pressure operation function interface menu carried in the converted installation package, and stores the converted data of the preset pressure operation function interface menu of the application in a storage unit having an access right; wherein the data of the preset pressure operation function interface menu carried in the installation package of the application is the data of the preset pressure operation function interface menu of the application specifically configured by an application developer according to the preset pressure information specification.

For example, an application A includes several function menus such as “Discussion”, “Community”, “Mine”, and “Settings”. The developer of the application A may configure the preset pressure operation function interface menu of the application A to contain the data of the function interface menus such as “Discussion”, “Community”, “Mine”, and “Settings”, or “Discussion”, “Community”, and “Mine”, according to the preset pressure information specification provided by the Android terminal manufacturer.

In step 104, when determining in a desktop application that a pressure operation is to select the function interface of the application, the data of the corresponding preset pressure operation function interface menu is retrieved from the storage unit according to icon information of the application.

To be specific, at first, the Android terminal will judge whether a duration of the pressure operation on the icon of the application is greater than or equal to a preset duration; and when the duration of the pressure operation on the icon of the application is less than the preset duration, a processing flow is ended.

When the duration of the pressure operation on the icon of the application is greater than or equal to the preset duration, the Android terminal acquires a pressure value of the pressure operation on the icon of the application, and determines whether the pressure value of the pressure operation is greater than or equal to a preset pressure threshold; and when the pressure value of the pressure operation is less than the preset pressure threshold, the processing flow is ended.

When the pressure value of the pressure operation is greater than or equal to the preset pressure threshold, the Android terminal determines that the pressure operation is to select the function interface of the application.

It should be noted that the preset duration and the preset pressure threshold may be set according to actual requirements, which are not limited herein.

Further, before determining whether the duration of the pressure operation on the icon of the application is greater than or equal to the preset duration, the Android terminal may further determine whether the application has an access right to access the storage unit firstly, and when the application does not have the access right to access the storage unit, the processing flow is ended.

When the application has the access right to access the storage unit, a subsequent process of determining whether the duration of the pressure operation on the icon of the application is greater than or equal to the preset duration may be performed.

In step 105, the data of the corresponding preset pressure operation function interface menu is presented.

The Android terminal presents the determined data of the corresponding preset pressure operation function interface menu on the desktop through an animation pop-up view, and by clicking on or sliding a data item of the function interface menu, the user can open the corresponding function of the application.

According to the method for implementing a function interface of an application by pressure provided by the embodiments of the present disclosure, the application component attribute is extended according to the preset pressure information specification by an Android terminal; the parsing mechanism and the packaging mechanism are extended according to the extended application component attribute; the data of the preset pressure operating function interface menu carried in the installation package of the application when the application is installed or updated is acquired by using the extended parsing mechanism and the extended packaging mechanism, and the data of the preset pressure operating function interface menu of the application is stored in the storage unit; when determining in the desktop application that the pressure operation is to select the function interface of the application, the data of the corresponding preset pressure operation function interface menu is retrieved from the storage unit according to the icon information of the application; and the data of the corresponding preset pressure operation function interface menu is presented. The method extends a system framework of the Android terminal according to the preset pressure information specification, and supports the data of the preset pressure operation function interface menu for the application configured according to the preset pressure information specification, solves the defects in the related art the corresponding pressure operation interface information of the application has to be uniformly configured in the desktop in advance, provides convenience for third-party applications to support the pressure operation characters and improves the user experience.

FIG. 2 is a structural schematic diagram of an embodiment of an apparatus for implementing a function interface of an application by pressure according to the present disclosure. As shown in FIG. 2, the apparatus for implementing a function interface of an application by pressure 02 includes an extension module 21, a conversion module 22, a processing module 23, and a presentation module 24.

The extension module 21 is configured to extend an application component attribute according to a preset pressure information specification; and extend a parsing mechanism and a packaging mechanism according to the extended application component attribute.

The conversion module 22 is configured to acquire data of a preset pressure operation function interface menu carried in an installation package of an application when the application is installed or updated by using the extended parsing mechanism and the extended packaging mechanism, and store the data of the preset pressure operation function interface menu of the application in a storage unit.

The processing module 23 is configured to, when determining in a desktop application that a pressure operation is to select the function interface of the application, retrieve the data of the corresponding preset pressure operation function interface menu from the storage unit according to icon information of the application.

The presentation module 24 is configured to present the data of the corresponding preset pressure operation function interface menu.

Further, the processing module 23 is specifically configured to, when a duration of the pressure operation on an icon of the application is greater than or equal to a preset duration, acquire a pressure value of the pressure operation on the icon of the application; and when the pressure value of the pressure operation is greater than or equal to the preset pressure threshold, determine that the pressure operation is to select the function interface of the application.

Further, the extension module 21 is specifically configured to extend the application component attribute according to a startup interface of the pressure operation, service information of the pressure operation, and a service parameter of the pressure operation of the application in the preset pressure information specification.

Further, the presentation module 24 is specifically configured to present the data of the corresponding preset pressure operation function interface menu on the desktop through an animation pop-up view.

Further, the data of the preset pressure operation function interface menu is formulated by the preset pressure information specification.

The application component attribute includes an Activity component attribute, a Service component attribute, a Broadcast Receiver component attribute and a Content Provider component attribute.

The apparatus of the embodiment may be configured to implement the technical solution of the foregoing method embodiment, and the implementation principle and the technical effect of the apparatus are similar, which will not be elaborated herein.

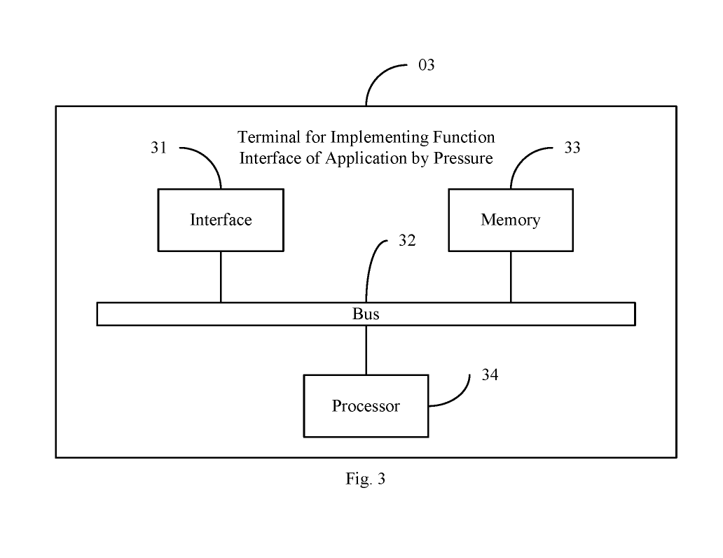

FIG. 3 is a structural schematic diagram of an embodiment of a terminal for implementing a function interface of an application by pressure according to the present disclosure. As shown in FIG. 3, the terminal for realizing a function interface of an application by pressure 03 includes an interface 31, a bus 32, a memory 33, and a processor 34, wherein the interface 31, the memory 33 and the processor 34 are connected through the bus 32, the memory 33 is configured to store an instruction, and the processor 34 reads the instruction to:

extend an application component attribute according to a preset pressure information specification;

extend a parsing mechanism and a packaging mechanism according to the extended application component attribute;

acquire data of a preset pressure operation function interface menu carried in an installation package of an application when the application is installed or updated by using the extended parsing mechanism and the extended packaging mechanism, and store the data of the preset pressure operation function interface menu of the application in a storage unit;

when determining in a desktop application that a pressure operation is to select the function interface of the application, retrieve the data of the corresponding preset pressure operation function interface menu from the storage unit according to icon information of the application; and

present the data of the corresponding preset pressure operation function interface menu.

Further, the processor reads the instruction to: when a duration of the pressure operation on an icon of the application is greater than or equal to a preset duration, acquire a pressure value of the pressure operation on the icon of the application; and

when the pressure value of the pressure operation is greater than or equal to a preset pressure threshold, determine that the pressure operation is to select the function interface of the application.

Further, the processor reads the instruction to: extend the application component attribute according to a startup interface of the pressure operation, service information of the pressure operation, and a service parameter of the pressure operation of the application in the preset pressure information specification.

Further, the data of the preset pressure operation function interface menu is formulated by the preset pressure information specification.

Further, the processor reads the instruction to: present the data of the corresponding preset pressure operation function interface menu on the desktop through an animation pop-up view.

Further, the application component attribute includes an Activity component attribute, a Service component attribute, a Broadcast Receiver component attribute and a Content Provider component attribute.

The terminal of the embodiment may be configured to implement the technical solution of the foregoing method embodiment, and the implementation principle and the technical effect of the apparatus are similar, which will not be elaborated herein.

Those skilled in the art will appreciate that embodiments of the present disclosure may be provided as a method, a system, or a computer program product. Accordingly, the present disclosure may take the form of a hardware embodiment, a software embodiment, or a combination embodiment of software and hardware. Moreover, the present disclosure may take the form of a computer program product embodied on one or more computer usable storage media (including but not limited to disk storage and optical storage, etc.) in which computer usable program codes are included.

The present disclosure has been described with reference to the flow charts and/or block diagrams of the method, device (system), and computer program products according to the embodiments of the present disclosure. It should be appreciated that each flow and/or block in the flow charts and/or block diagrams, and combinations of the flows and/or blocks in the flow charts and/or block diagrams may be implemented by computer program instructions. These computer program instructions may be provided to a general purpose computer, a special purpose computer, an embedded processor, or a processor of other programmable data processing device to produce a machine for the instructions executed by the computer or the processor of other programmable data processing device to generate an apparatus for implementing the functions specified in one or more flows of the flow chart and/or in one or more blocks of the block diagram.

These computer program instructions may also be provided to a computer-readable memory that may guide the computer or other programmable data processing device to work in a given manner, so that the instructions stored in the computer-readable memory generate a product including an instruction apparatus that implements the functions specified in one or more flows of the flow chart and/or in one or more blocks of the block diagram.

These computer program instructions may also be loaded to a computer, or other programmable data processing device, so that a series of operating steps are executed on the computer, or other programmable data processing device to produce processing implemented by the computer, so that the instructions executed in the computer or other programmable data processing device provide steps for implementing the functions specified in one or more flows of the flow chart and/or in one or more blocks of the block diagram.

The above description merely relates to embodiments of the present disclosure, but is not intended to limit the protection scope of the present disclosure.

### INDUSTRIAL APPLICABILITY

The foregoing technical solutions provided by the embodiments of the present disclosure may be applied to the process of implementing the function interface of the application by pressure for extending the application component attribute according to the preset pressure information specification by using an Android terminal; extending the parsing mechanism and the packaging mechanism according to the extended application component attribute; acquiring the data of the preset pressure operating function interface menu carried in the installation package of the application when the application is installed or updated by using the extended parsing mechanism and the extended packaging mechanism, and storing the data of the preset pressure operating function interface menu of the application in the storage unit; when determining in the desktop application that the pressure operation is to select the function interface of the application, retrieving the data of the corresponding preset pressure operation function interface menu from the storage unit according to the icon information of the application; and presenting the data of the corresponding preset pressure operation function interface menu. The method extends a system framework of the Android terminal is extended according to the preset pressure information specification, and supports the data of the preset pressure operation function interface menu for the application configured according to the preset pressure information specification, solves the defects in the prior art the corresponding pressure operation interface information of the application has to be uniformly configured in the desktop in advance, and provides convenience for third-party applications to support the pressure operation characters.

1.-11. (canceled)

12. A method for implementing a function interface of an application by pressure, comprising:
extending an application component attribute according to a preset pressure information specification;
extending a parsing mechanism and a packaging mechanism according to the extended application component attribute;
acquiring data of a preset pressure operation function interface menu carried in an installation package of an application when the application is installed or updated by using the extended parsing mechanism and packaging mechanism, and storing the data of the preset pressure operation function interface menu of the application in a storage unit;
when determining in a desktop application that a pressure operation is to select the function interface of the application, retrieving the data of the corresponding preset pressure operation function interface menu from the storage unit according to icon information of the application; and
presenting the data of the corresponding preset pressure operation function interface menu.

13. The method according to claim 12, wherein the determining in the desktop application that the pressure operation is to select the function interface of the application comprises:
when a duration of the pressure operation on an icon of the application is greater than or equal to a preset duration, acquiring a pressure value of the pressure operation on the icon of the application; and
when the pressure value of the pressure operation is greater than or equal to a preset pressure threshold, determining that the pressure operation is to select the function interface of the application.

14. The method according to claim 12, wherein the extending the application component attribute according to the preset pressure information specification comprises:
extending the application component attribute according to a startup interface of the pressure operation, service information of the pressure operation, and a service parameter of the pressure operation of the application in the preset pressure information specification.

15. The method according to claim 12, wherein the data of the preset pressure operation function interface menu is formulated by the preset pressure information specification.

16. The method according to claim 12, wherein the presenting the data of the corresponding preset pressure operation function interface menu comprises:
presenting the data of the corresponding preset pressure operation function interface menu on a desktop through an animation pop-up view.

17. The method according to claim 12, wherein the application component attribute comprises an Activity component attribute, a Service component attribute, a Broadcast Receiver component attribute and a Content Provider component attribute.

18. The method according to claim 13, wherein the application component attribute comprises an Activity component attribute, a Service component attribute, a Broadcast Receiver component attribute and a Content Provider component attribute.

19. The method according to claim 14, wherein the application component attribute comprises an Activity component attribute, a Service component attribute, a Broadcast Receiver component attribute and a Content Provider component attribute.

20. The method according to claim 15, wherein the application component attribute comprises an Activity component attribute, a Service component attribute, a Broadcast Receiver component attribute and a Content Provider component attribute.

21. The method according to claim 16, wherein the application component attribute comprises an Activity component attribute, a Service component attribute, a Broadcast Receiver component attribute and a Content Provider component attribute.

22. An apparatus for implementing a function interface of an application by pressure, comprising:
a processor; and
a memory for storing instructions executable by the processor;
wherein the processor is configured to:
extend an application component attribute according to a preset pressure information specification; and extend a parsing mechanism and a packaging mechanism according to the extended application component attribute;
acquire data of a preset pressure operation function interface menu carried in an installation package of an application when the application is installed or updated by using the extended parsing mechanism and packaging mechanism, and store the data of the preset pressure operation function interface menu of the application in a storage unit;
when determining in a desktop application that a pressure operation is to select the function interface of the application, retrieve the data of the corresponding preset pressure operation function interface menu from the storage unit according to icon information of the application; and
present the data of the corresponding preset pressure operation function interface menu.

23. The apparatus according to claim 22, wherein the processor is further configured to, when a duration of the pressure operation on an icon of the application is greater than or equal to a preset duration, acquire a pressure value of the pressure operation on the icon of the application; and when the pressure value of the pressure operation is greater than or equal to a preset pressure threshold, determine that the pressure operation is to select the function interface of the application.

24. The apparatus according to claim 22, wherein the processor is further configured to extend the application component attribute according to a startup interface of the pressure operation, service information of the pressure operation, and a service parameter of the pressure operation of the application in the preset pressure information specification.

25. The apparatus according to claim 22, wherein the processor is further configured to present the data of the corresponding preset pressure operation function interface menu on a desktop through an animation pop-up view.

26. The apparatus according to claim 22, wherein the data of the preset pressure operation function interface menu is formulated by the preset pressure information specification; and
the application component attribute comprises an Activity component attribute, a Service component attribute, a Broadcast Receiver component attribute and a Content Provider component attribute.

27. The apparatus according to claim 23, wherein the data of the preset pressure operation function interface menu is formulated by the preset pressure information specification; and
the application component attribute comprises an Activity component attribute, a Service component attribute, a Broadcast Receiver component attribute and a Content Provider component attribute.

28. The apparatus according to claim 24, wherein the data of the preset pressure operation function interface menu is formulated by the preset pressure information specification; and
the application component attribute comprises an Activity component attribute, a Service component attribute, a Broadcast Receiver component attribute and a Content Provider component attribute.

29. The apparatus according to claim 25, wherein the data of the preset pressure operation function interface menu is formulated by the preset pressure information specification; and
the application component attribute comprises an Activity component attribute, a Service component attribute, a Broadcast Receiver component attribute and a Content Provider component attribute.

30. A computer storage medium, wherein the computer storage medium is stored with a computer-executable instruction, and the computer-executable instruction is configured to perform:
extending an application component attribute according to a preset pressure information specification;
extending a parsing mechanism and a packaging mechanism according to the extended application component attribute;
acquiring data of a preset pressure operation function interface menu carried in an installation package of an application when the application is installed or updated by using the extended parsing mechanism and packaging mechanism, and storing the data of the preset pressure operation function interface menu of the application in a storage unit;
when determining in a desktop application that a pressure operation is to select the function interface of the application, retrieving the data of the corresponding preset pressure operation function interface menu from the storage unit according to icon information of the application; and
presenting the data of the corresponding preset pressure operation function interface menu.
